(19) United States
(12) Patent Application Publication
(10) Pub. No.: US 2022/0398547 A1
(43) Pub. Date: Dec. 15, 2022

(54) SYSTEM AND METHOD FOR AI-BASED TASK MANAGEMENT

(71) Applicant: Ruichen Wang, Sunnyvale, CA (US)

(72) Inventor: Ruichen Wang, Sunnyvale, CA (US)

(21) Appl. No.: 17/836,498

(22) Filed: Jun. 9, 2022

Related U.S. Application Data
(60) Provisional application No. 63/208,706, filed on Jun. 9, 2021.

(51) Int. Cl. G06Q 10/10; G06Q 10/06; G06N 20/00

(52) U.S. Cl. CPC G06Q 10/1097; G06Q 10/063112; G06Q 10/0639; G06N 20/00

(57) ABSTRACT

The present teaching relates to method, system, medium, and implementations for task management. When information related to at least one task to be carried out by a user is received, multiple features associated with each of the at least one task are predicted automatically based on a plurality prediction models, derived based on historic information related to the user in carrying out past tasks. The at least one task is then automatically scheduled in a calendar associated with the user based on the multiple features predicted for each of the at least one task to generate an updated calendar with the at least one task scheduled therein.

### CROSS-REFERENCE TO RELATED APPLICATION

The present application claims the benefit of U.S. Provisional Patent Application No. 63/208,706, filed Jun. 9, 2021, which is hereby incorporated by reference in its entirety.

### BACKGROUND

In today's society, multi-tasking has become a way of living and it is a common place that one may daily be faced with a suite of tasks, including short term, long term, work-related, and private task. It has become increasingly challenging to keep one's attention focused on all tasks, especially on long term projects or personal goals in this era with an explosive amount of information coming directly at us every second with constant distraction. People typically have various types of sub-tasks or sub-goals to achieve everyday so that it is even harder if one has to continuously manage on a daily basis in order to complete multiple sub-tasks or sub-goals in order to achieve the goals with respect to different tasks, whether short term or long term.

In order to pursue a long-term goal, one typically needs to either chunk the task into several sub-tasks or steps to work on different days or remember to do some repetitive work/practice at some appropriate time frequency. However, with too many daily distractions as it commonly occurs to everyone, it is quite likely to forget to do some tasks for, e.g., a long-term goal, or forget about the current progress status of a long-term task and, hence, need time to re-orient oneself to the current state of a task to pick up where it is left off, wasting time and energy. One reason for being forgetful is related to the so-called attention capacity, i.e., one can only focus on a few things at a time. When distractions such as errands start to take up one's attention capacity, long term goal tasks sometimes get pushed out of one's focus.

Different efforts have been attempted to provide assisting tools to help people to keep track of tasks. For example, such tools include calendar and/or other project management tools to keep track of to-do list. Although such tools are useful, there are still some critical drawbacks. For instance, they still lack of intelligent and dynamic management functions so that the task list entered into such tools become stale with time and once that happens, it is again unmanageable with the same issues.

In addition, most tools for managing productivity usually require a user to actively interact with the task list to manually update the status, which adds unavoidable management burden and waste human resources, particularly when the list is long such as those that grow outside of the user's attention capacity. Furthermore, when a user finishes certain tasks, the user may forget to check off the completed tasks. When that occurs, the user's pending task list may become longer and longer without reflecting the actual status on the completion. Another issue is that one may keep adding new tasks without being able to maintain the priorities dynamically of different tasks in light of the new tasks added. This may also cause that the task list growing outside of one's attention capacity. These scenarios often quickly make the task list stale and unmanageable after some time.

Thus, there is a need for solutions that address the deficiencies of the conventional solutions.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to a network for task management is disclosed. When information related to at least one task to be carried out by a user is received, multiple features associated with each of the at least one task are predicted automatically based on a plurality prediction models, derived based on historic information related to the user in carrying out past tasks. The at least one task is then automatically scheduled in a calendar associated with the user based on the multiple features predicted for each of the at least one task to generate an updated calendar with the at least one task scheduled therein.

In a different example, a task management system or framework is disclosed for supporting the method to task management according to the present teaching.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for task management. When information related to at least one task to be carried out by a user is received, multiple features associated with each of the at least one task are predicted automatically based on a plurality prediction models, derived based on historic information related to the user in carrying out past tasks. The at least one task is then automatically scheduled in a calendar associated with the user based on the multiple features predicted for each of the at least one task to generate an updated calendar with the at least one task scheduled therein.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts a networked framework in which client devices collect inputs and collaborate with one or more servers through network to achieve dynamic task management, in accordance with an embodiment of the present teaching;

FIG. 2A illustrates an exemplary user interface on a client device with different views, in accordance with an embodiment of the present teaching;

FIG. 2B illustrates an exemplary interface associated with a project view, in accordance with an embodiment of the present teaching;

FIG. 2C illustrates an exemplary interface associated with a todolist view, in accordance with an embodiment of the present teaching;

FIG. 2D illustrates an exemplary interface associated with a calendar view, in accordance with an embodiment of the present teaching;

FIG. 2E illustrates an exemplary interface page of a selected task, in accordance with an embodiment of the present teaching;

FIG. 3 illustrates an exemplary flow of steps with regard to task management, in accordance with an embodiment of the present teaching;

FIG. 4A depicts exemplary relevant AI-based components and interconnections thereof, in accordance with an embodiment of the present teaching;

FIG. 4B depicts an exemplary scheme of obtaining and applying AI-based personalized model for estimating task priority, in accordance with an embodiment of the present teaching;

FIG. 4C depicts an exemplary scheme of obtaining and applying AI-based personalized model for predicting task duration and task rearrangement, in accordance with an embodiment of the present teaching;

FIG. 4D depicts an exemplary scheme of obtaining and applying AI-based personalized model for predicting task start time and task rearrangement, in accordance with an embodiment of the present teaching;

FIG. 4E illustrates exemplary approaches for AI-based personalized global task optimization and re-arrangement, in accordance with an embodiment of the present teaching;

FIG. 5A is a flowchart of an exemplary process of adding/updating a task with AI-based task priority determination and task rearrangement, in accordance with an embodiment of the present teaching;

FIG. 5B is a flowchart of an exemplary process of removing/marking a completed task with AI-based automated task list update and rearrangement, in accordance with an embodiment of the present teaching;

FIG. 5C illustrates exemplary types of information/statistics automatically made available via AI-based models, in accordance with an embodiment of the present teaching;

FIG. 6 depicts an exemplary scheme of automatically detecting duplicated tasks via machine learning, in accordance with an embodiment of the present teaching;

FIG. 7 depicts an exemplary scheme of applying AI-based personalized task management framework to collaborated team project management, in accordance with an embodiment of the present teaching;

FIG. 8 depicts an exemplary scheme of applying AI-based personalized task management framework to marketplace knowledge sharing, in accordance with an embodiment of the present teaching;

FIG. 9 is an illustrative diagram of an exemplary mobile device architecture that may be used to realize a specialized system implementing the present teaching in accordance with various embodiments; and

FIG. 10 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present teaching relates to method, system, and implementation of intelligent and personalized task management, based on learning, to help a user to manage team or personal related tasks/projects. The present teaching as disclosed herein manages tasks/projects automatically via knowledge learned from past data to assist users to effectively manage tasks (including task scheduling, operational flow, and adjustment to the scheduled tasks based on the execution dynamics) with minimum required user manual interactions with a task list (unless the user wants to) to enhance efficiency and user experience. The approaches as disclosed herein make task management more like an automated personal assistant.

The present teaching as disclosed herein provides an effective personal assistant to a user in task management with minimum task management overhead with enhanced and personalized user experience.

The present teaching enables learning of personalized model(s), with respect to each individual user, for estimating priority of each new/updated task, predicting starting time and/or duration of each task, dynamically rearrange tasks in accordance with estimated priorities, allowing each user to manage a list of tasks with much reduced burden and gain efficiency. In this way, a user can maintain and follow a task list within the user's attention capacity.

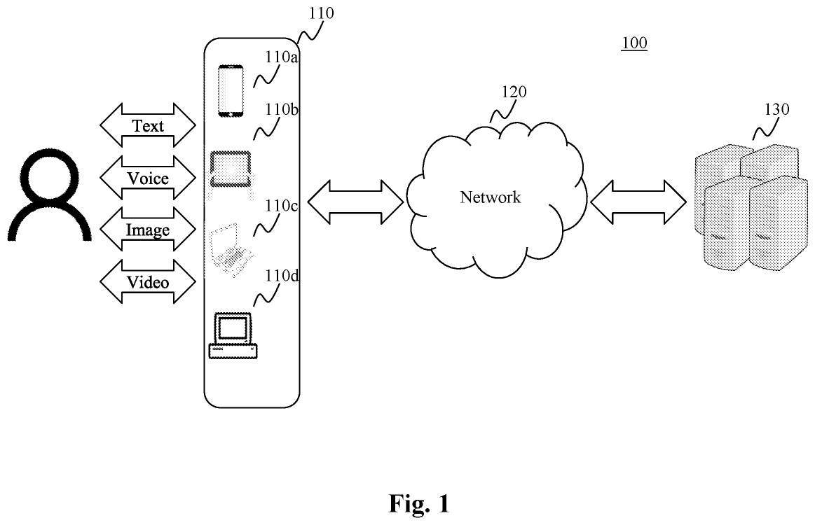

The present teaching is an app/software/website/etc. tool that helps a user manage their personal/team projects. FIG. 1 depicts a networked framework 100 in which client devices 110 collect inputs and collaborate with one or more servers 130 through network 120 to achieve dynamic task management, in accordance with an embodiment of the present teaching. As shown, framework 100 comprises one or more user devices 110, e.g., 110a, 110b, . . . , 110c, and 110d, and application servers 130. The communications among different parties in this framework is via network 120. The task management system implemented in accordance with the present teaching may reside, either fully or partially, on server 130 and may be accessed through any of the user devices 110. In some embodiments, the task management system implemented according to the present teaching may reside on the server 130 and each device may be dispatched with an instantiated version of the task management system residing on a server. An instantiated version of the task management system deployed on a device may evolve on its own to form personalized version with model learned based on data associated with the user of the device. The communication between devise and servers may be conducted in different signal forms such as text, voice, image, video, etc.

In the illustrated framework 100, network 120 may correspond to a single network or a combination of different networks. For example, network 120 may be a local area network (“LAN”), a wide area network (“WAN”), a public network, a proprietary network, a proprietary network, a Public Telephone Switched Network (“PSTN”), the Internet, an intranet, a Bluetooth network, a wireless network, a virtual network, and/or any combination thereof. In some embodiments, network 120 may also include various network access points (not shown). For example, environment 100 may include wired or wireless access points such as, without limitation, base stations or Internet exchange points, where base stations may facilitate, for example, communications to/from user devices 110 or to/from application clients and the application server 130. Such communications may involve different types of sub-networks connected and one or more different types of components in the networked framework 100 across different types of network.

A user device, e.g., 110-a, may be of different types to facilitate a user operating the user device to connect to network 120 and transmit/receive signals. Such a user device 110 may correspond to any suitable type of electronic/computing device including, but not limited to, a mobile device (110a), a pad (110b), . . . , a mobile computer (110c), or a stationary device/computer (110d). A mobile device may include, but is not limited to, a mobile phone, a smart phone, a personal display device, a personal digital assistant (“PDAs”), a gaming console/device, a wearable device such as a watch, a Fitbit, a pin/broach, a headphone, etc. A mobile computer may include a laptop, an Ultrabook device, a handheld device, etc. A stationary device/computer may include a computer, a television, a set top box, a smart household device (e.g., a refrigerator, a microwave, a washer or a dryer, an electronic assistant, etc.), and/or a smart accessory (e.g., a light bulb, a light switch, an electrical picture frame, etc.).

In this illustrated network environment, when the task management system according to the present teaching is running on a user device, say 110a, it progresses by going through different state transitions and such state transitions may be triggered by interactions of the user. These state transitions may or may not further trigger communications to be sent to servers 130 through network 120 in order to get some response from services running on the servers. Similarly, when a response is received from a server, such a response may or may not further trigger a state transition on the user device.

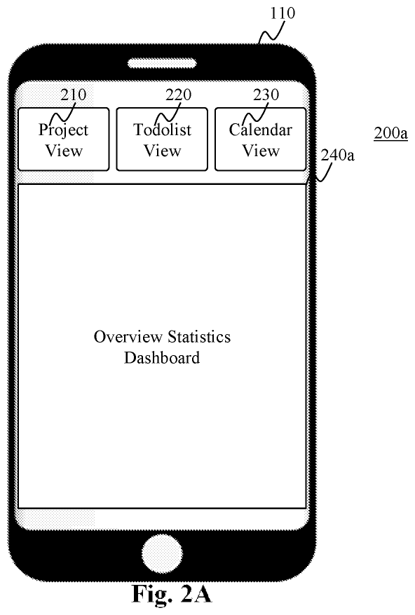

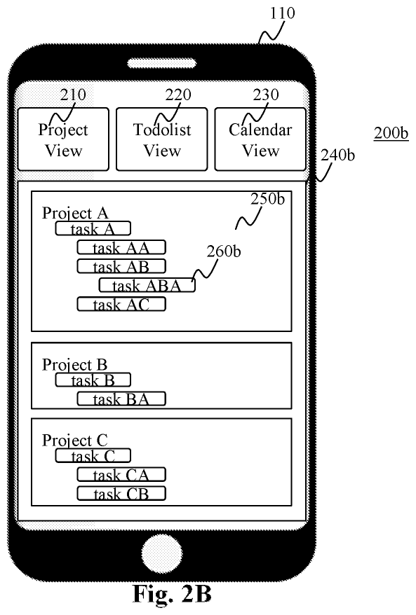

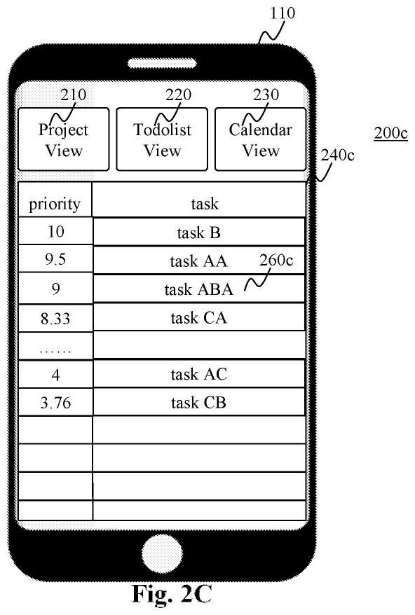

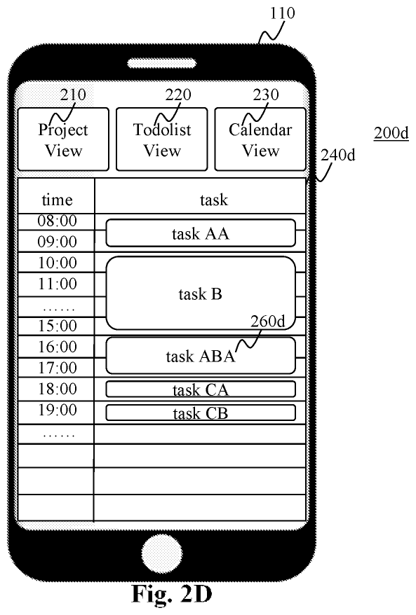

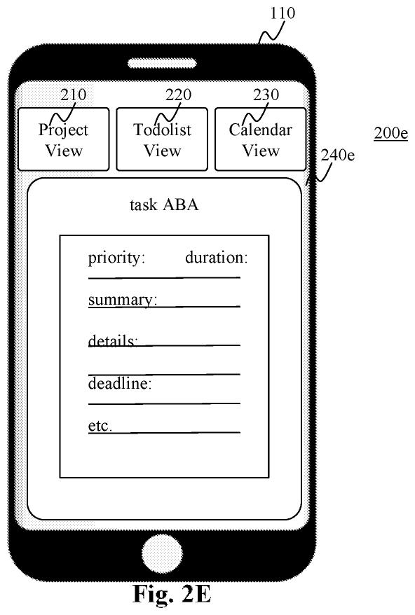

FIGS. 2A-2E illustrate different exemplary user interfaces of the task management system running on a client (user) device with different views, in accordance with an embodiment of the present teaching. It is noted that although exemplary interfaces are provided to show various functionalities of the present teaching, these examples are provided merely for illustrations and they are not intended to serve as limitations on the scope of the present teaching. Any other interfaces for achieving task management using AI based techniques, whether in a specific form or content, are within the scope of the present teaching.

FIG. 2A illustrates an exemplary user interface on a client device 110 with different exemplary views, in accordance with an embodiment of the present teaching. In this illustrated embodiment, there are three views, accessible from an application running on the device corresponding to the instantiated version of the task management system implemented according to the present teaching. These exemplary views include, e.g., a project view 210, a todolist view 220, and a calendar view 230. In some embodiments, these three views may be operated in sync in an intelligent way, i.e., for any changes made to a task in one of the views, corresponding changes are consistently made in other views accordingly in a consistent manner. As will be explained, this is achieved based on AI-based models established via machine learning in a personalized fashion.

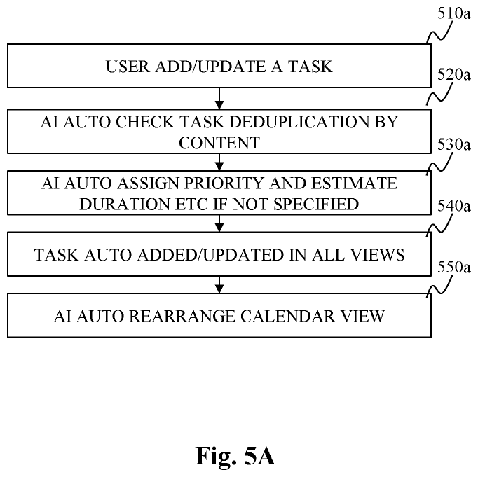

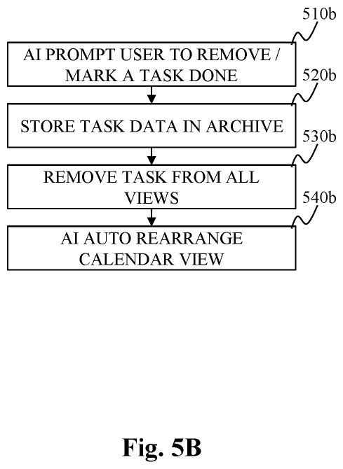

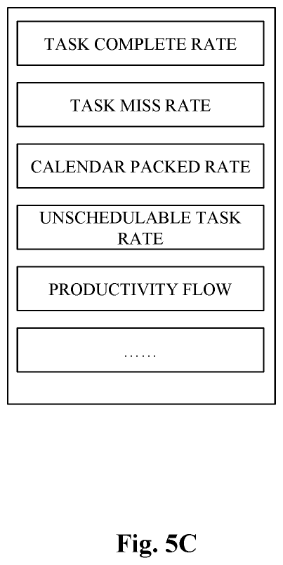

As shown, FIG. 2A provides an exemplary interface 200a with a design as illustrated. In this embodiment, for each of the exemplary views, there is a tab which may be selected as the desired active view. There is a dashboard displaying area 240a for displaying, on the interface, information related to a selected view. For example, statistics related to the project view may be displayed in 240a when project view 210 is selected. Multiple types of information, e.g., statistics, may be displayed in the dashboard 240a. One example is shown in FIG. 5C, where various statistics are illustrated, including but are not limited to task completion rate, task missing rate, calendar packed rate, a percent of tasks that cannot be scheduled, productivity flow, etc. They will be explained individually below. In some embodiments, statistics may be displayed in the dashboard area 240a in various forms in order to help the user quickly understand how well they are doing with their scheduled tasks, including, e.g., numbers, bar charts, line charts, pie charts, scatter plots, histograms, animations, etc.

FIG. 2B illustrates an exemplary interface 200b associated with the project view 220, in accordance with an embodiment of the present teaching. In this illustration, the dashboard displaying area 240b is used to display information related to projects that the user is currently managing. In this example, task lists associated with three projects, i.e., Project A, Project B, and Project C, are provided. Each project, e.g., 250b may be broken down to tasks arranged in a hierarchical manner. For example, in Project A 250b may include multiple tasks, e.g., task A, etc. and each task is further broken down into subtasks. As seen, task A under Project A is further broken down to task AA, task AB and task AC. Task AB is further broken down to task ABA etc. The tasks included under each project in this view correspond to those on both the todolist view and the calendar view associated with the same project.

When a user interacts in any of the views of the task management system of the present teaching to make a change, e.g., adding, updating, or removing, or marking completed projects/tasks, the changes are used to automatically incorporate consistent changes across different views. For instance, if a change is made in the project view 210, the other two views, i.e., todolist view and calendar view, are updated intelligently with the corresponding task changes. As will be disclosed hereinunder, such consistent changes are made in a personalized way based on AI based models learned in accordance with the present teaching.

FIG. 2C illustrates an exemplary interface 200c associated with the todolist view 220, in accordance with an embodiment of the present teaching. In this illustration for the todolist view 220, the corresponding dashboard display area 240c that is used to display tasks in a to-do list. In some embodiments, each task in this to-do list may be associated with a priority score, which may be either specified by a user or predicted by an AI-based model, when the user does not assign a priority score manually. In some embodiments, tasks on a todolist may be ranked based on their priority scores and they may be displayed according to that rank order (as illustrated in FIG. 2C). As discussed herein, tasks under different views are consistently maintained.

Similarly, a user may interact with the task management system implemented according to the present teaching, e.g., to add, update, remove, and mark complete tasks in the todolist view 220 and any changes made in the todolist view are to be accordingly and consistently maintained in the other views, i.e., the project view and calendar view. In this manner, the tasks are managed across different views in a personalized manner in accordance with the AI based models, which will be described below.

FIG. 2D illustrates an exemplary interface 200d associated with the calendar view 230, in accordance with an embodiment of the present teaching. In this exemplary interface for the calendar view, a dashboard display area for the calendar view, or 240d, is used to display a panel with a personalized user's calendar. As shown in FIG. 2D, a list of tasks scheduled in the calendar for a particular day is displayed in 240d. Each task in this example has a start time and an end time that are either specified by the user or predicted by an AI-based model (as to be discussed below) when the user chooses not to enforce manually. In this illustrated example, the tasks are assigned into the calendar time according to their start and end time and sequentially arranged in corresponding time slots accordingly. Tasks listed here are consistently and coherently maintained across all different views.

As discussed herein, information associated with different views is synchronized dynamically. For example, if the user adds a task ABA 260b in the project view 200b, a task ABA 260c is added to the to-do list associated with the todolist view 200c, and a task ABA 260d added to the calendar associated with the calendar view 200d. If the user does not specify a priority score to the task ABA, an AI-based model, learned from the user's previous behaviors (may be other users' past data as well), may be used to predict a priority score for the added task. In some embodiments, if the AI-based model is personalized (e.g., trained using past data of the same user), the predicted priority score reflects the user's personal habits regarding how they typically prioritize tasks that were similar to the current task ABA. With a priority score, the task is then accordingly added to a the todolist so that the list is, e.g., ordered according to the priority scores.

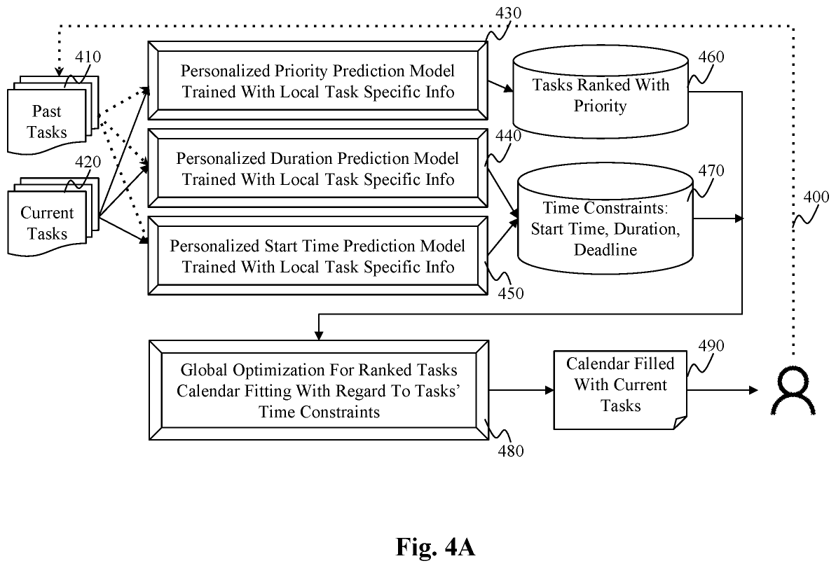

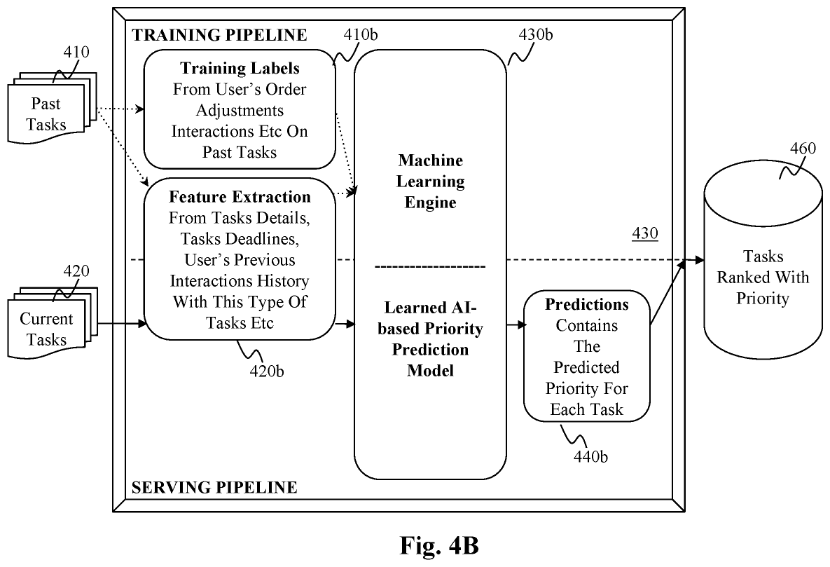

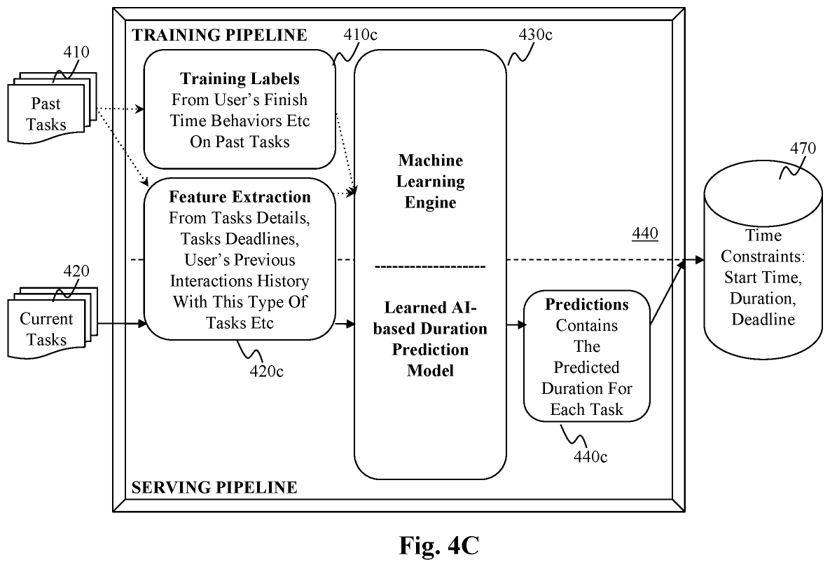

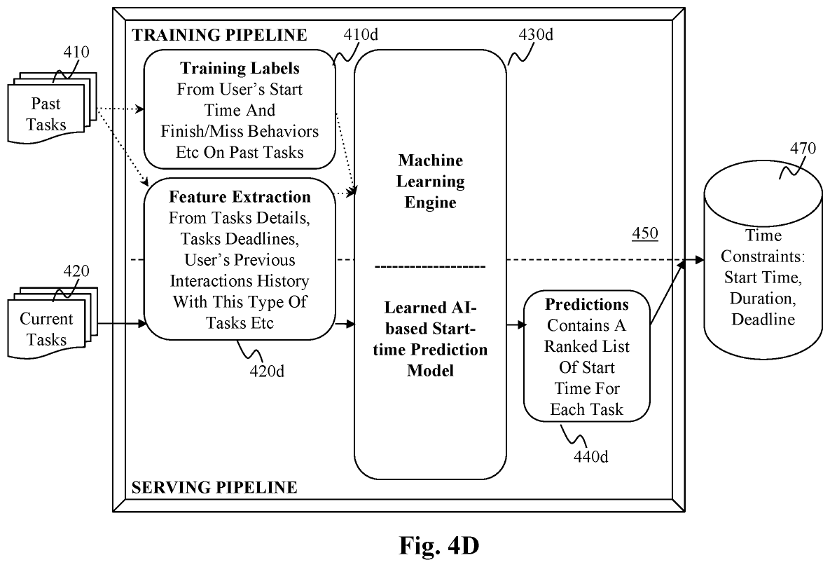

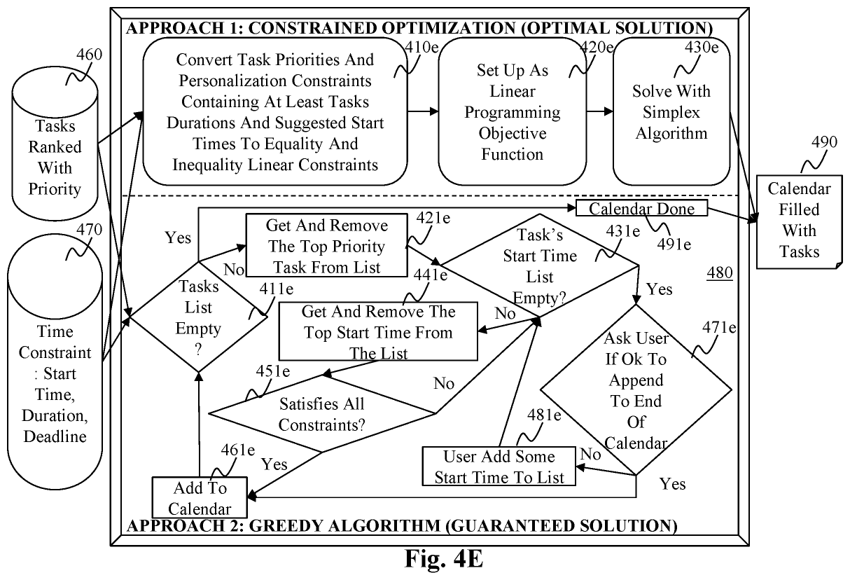

In some embodiments, the start time and end time (duration) for an added task may also be estimated. This may be done by the user or, when the user does not specify when entering the task, AI-based models established via machine learning based on the user's previous behaviors, may be invoked to predict the start time and duration of the added task. When the start time and duration are predicted using a personalized AI-based model, the prediction reflects the user's personalized habits regarding when the user typically likes to work on such type of task and how long it usually takes the user to finish such type of task. With the predicted priority, start time, and duration for an added task, another AI-based global optimization model trained to rearranges all existing tasks, including the added task, in the calendar, which will be explained in detail with respect to FIGS. 4A-4E below. Similarly, when a task is updated, e.g., partially completed, similar estimation may be applied so that the priority, start time, and duration for relevant tasks may be updated as well and the schedule of the tasks may also be accordingly updated.

As another example, if a user removes a task, the same task is to be removed from information associated with all views and remaining tasks may be rearranged. Specifically, with respect to the calendar view, after a task is removed, a global optimization model may be triggered to rearrange all remaining tasks in the calendar. Similarly, when a task is fully completed, the same may be performed because a completed task can be removed from the pending list of tasks. In some situation, when a task is partially completed, the remaining duration of the task changed. In this case, in addition to the change in remaining duration for the task, its priority may be changed as well. Given that, the remaining tasks, including the partially unfinished task, may be rearranged according to the updated priority and duration.

As discussed herein, any user interactions with any tasks in any of the views are synced across all views in a coherent and consistent manner. As it should be noted, although three views are described to explain some of the concepts associated with the present teaching, they are merely for illustration instead of for limitation. The interactions may include, but are not limited to, adding a task, updating a task, removing a task, marking a task status, etc. Similarly, these exemplary types of interactions are described merely as illustration and are not to be construed to limit the scope of the present teaching.

FIG. 2E illustrates an exemplary interface page showing details related to a selected task, in accordance with an embodiment of the present teaching. In some embodiments, a user may need to review specific information associated with a particular task. This may be done by interacting with the task in any view and requesting to review or edit detailed information of the task. In this situation, task related detailed information associated with the task at issue may be displayed in the dashboard display area, e.g., 240e in FIG. 2E. Through this page, a user may be provided with means to specify, modify, or provide data or instructions regarding any type of task specific information. For instance, a user may specify task priority, duration, deadline related to each task. In some situation, a user may instruct that the user desires to keep eliminating certain information. In some situations, additional information may be provided, including but not limited to a summary or extra detail about a task in the form of, e.g., text, voice, image, video, etc.

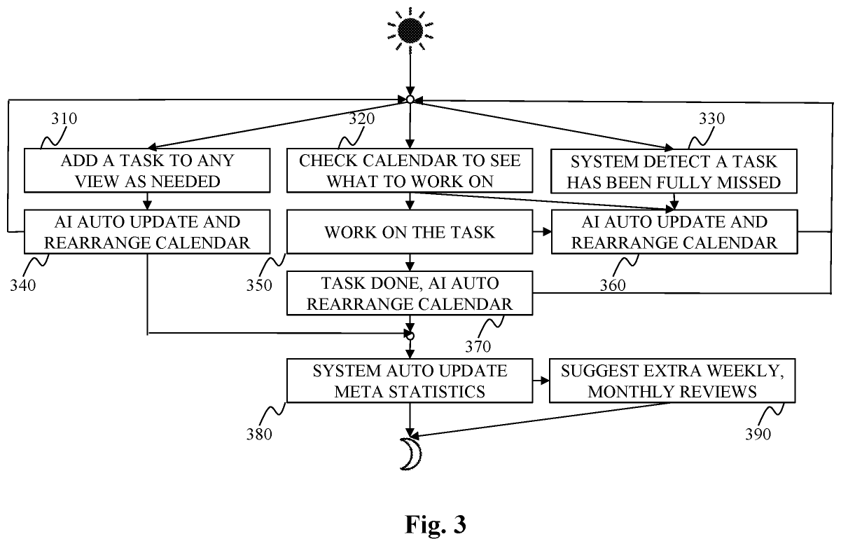

FIG. 3 illustrates an exemplary flow of steps with regard to task management, in accordance with an embodiment of the present teaching. This is for only the purpose of illustrating related concepts and is not for limitation in terms of possible user's interactions. In this illustrated example, at the start of a day, a user may check, at 320, relevant tasks on the task list by activating the calendar view to see what to work on. After that, the user may work on, at 350, the task that has been scheduled at that time. Alternatively, the user may also choose to update the task if the user decides that it may not be a good time to work on the task. If so, the calendar may be automatically updated and tasks remaining on the calendar may be rearranged at 360. In some embodiments, the calendar update, including rearranging the scheduled tasks may be performed via an AI based model, which may be obtained via machine learning so that the calendar update and rearrangement of tasks may be performed in a personalized fashion. Once the rearrangement of tasks on the calendar is completed, the user may check the updated calendar at 320 and determine a task to work on, at 350, based on the rearranged task list. When the user completes the work, the user may proceed to mark the task as “done.” Given the finished status associated with the task just completed, the AI based system according to the present teaching may automatically update the calendar and rearrange, at 370, the remaining tasks in a personalized fashion. Then the user may go back to step 320 and check the next task.

During the course of the day, the user may add a new task, this is performed at 310 via any of the views and, as discussed herein, AI based system may coordinate among different views to ensure that the information across different views is consistent and coherent. The AI-based system may also automatically update, at 340, the calendar and rearrange the current list of tasks in the calendar. As discussed herein, an AI-based model may be obtained via machine learning based on user's historic data so that the model is personalized so that the update and rearrangement of the calendar are completed in a personalized manner.

In some embodiments, the AI-based system according to the present teaching may also provide the functions to automatically monitor the execution of a task and detect, at 330, whether a task has not been executed (missed) against the calendar. If that id detected, the AI based system may automatically update and rearrange, at 360, the calendar in a personalized fashion with a newly suggested task time for the missing task. After such rearrangement, all other related information such as different statistics as illustrated in FIG. 5C may also be automatically updated at 380 so that the information maintained in the system accurately reflects the same accordingly. According to the observed executions of different tasks, the AI-based system may also suggest, at 390, additional follow-up reviews at certain time intervals such as weekly, monthly, etc. Such additional review may be done by the user or by the system automatically.

FIGS. 4A-4E provide details related to different aspects of the AI-based system according to some exemplary embodiments of the present teaching. Specifically, FIG. 4A depicts exemplary relevant AI-based components and high-level interconnections thereof, in accordance with an embodiment of the present teaching. Presented in FIG. 4A is the AI-based calendar tasks rearrangement related module. The past historic data related to a user on task management is collected for training different AI-based models, which includes previously recorded task management information (schedules, executions, updates, etc.) and the user's recorded interactions with such historic tasks (400). Based on such personalized historic data, several AI-based models may be personalized via machine learning. Such obtained models include, but not limited to, a task priority prediction model 430, a task duration prediction model 440, a task start time prediction model 450, etc. The task priority prediction model 430 is to be used to predict, given a task, the priority of the task. The user may have certain preferences as to priority with respect to different types of tasks and the model 430 captures, from past historic data, the user's preferences on priority of different tasks. The task duration prediction model 440 is to be used to predict the duration to carry out a specific task. The model 440 characterizes lengths of time needed to carry out different types of tasks. The task start time prediction model 450 is to be used to characterize typical starting time of different types of tasks. For example, a user may have certain habits in terms of doing certain things at different times. When these models are trained using historic data specific to a particular user, the derived models are personalized so that task management schedules generated in accordance with these models may be personalized. Upon these models being trained, given a list of current tasks stored in 420 (e.g., a list of tasks related to a user), the models may be used to automatically generate different preferences or limitations that can be used to generate a schedule or calendar the events for executing these current tasks. For instance, the using the priority prediction model 430, a priority for each of the current tasks may be predicted. Based on the duration prediction model 440, a duration to complete each of the current tasks may be estimated. This duration may be personalized based on an individual so that the duration predicted is related to the length of time the specific user may need to complete the task. Using the start time prediction model 450, for each of the current tasks, a start time may be estimated based on, e.g., what the user historically likes to start a similar task, captured by the model.

Based on such predicted parameters, a schedule for carrying out the current tasks may be generated and fit into the calendar. Specifically, given the current tasks from 420, the trained priority prediction model 430 may be invoked to produce a prioritized list of current tasks and save the prioritized list in storage 460. In addition, given the current tasks from 420, the trained duration prediction model 440 and trained start time prediction model 450 may be used to generate a set of time constraints (stored in storage 470) for each of the current tasks. Such constraints include, but are not limited to, task start time, task duration, task deadline, etc. With the prioritized list of current tasks in 460 and time constraints in 470, a global optimization module 480, constructed in accordance with the present teaching, may be invoked to personalize and arrange the current list of tasks into a calendar with respect to the predicted priorities and various time constraints. This produces a calendar 490 scheduled with the current tasks. This calendar may then be used by the user to manage the execution. During execution, additional user interactions and monitoring data may be continuously collected to provide additional training data, which may then be used further in training to refine models 430, 440, 450, etc. via machine learning.

FIG. 4B depicts an exemplary scheme for obtaining and applying the AI-based personalized model 430 for estimating task priority, in accordance with an embodiment of the present teaching. In this illustration, the part above the dashed line is related to training of the model and the part below the dashed line is related to applying the trained model in service operation. At training time, training data 410 is provided with extracted labels 410b (serve as ground truth) and features 420b extracted from the historic task management records with past tasks and the user's previous interactions. The training data 410 may also include information on previous task order adjustment by the user via interactions with respect to past scheduled sequence of past tasks in the calendar. Such information is helpful to train a task priority prediction model to capture the user's priority preference on previous tasks which assists accurate predictions on similar tasks.

With regard to features used in training against ground truth labels, various types of features may be included, including but not limited to, task features, timing or duration related features, user features, user interaction features, etc. The labels and features and any other types of information accessible from the training data are fed into an AI-based machine learning model 430b for training. The model training may be carried out using any type of supervised machine learning approach, including but not limited to, logistic regression, naive bayes, support vector machine, decision tree, adaboost, gradient boosting machine, random forest, neural networks, and any type of deep learning architectures, etc., either existing or developed in the future. The trained model is made accessible to the service operation in the serving pipeline and can be used to make predictions. Specifically, for any of the current tasks in 420, different types of information associated with the task may be provided such as task details, task deadlines, user's interaction information such as definitions or instructions, etc. Feature's extraction may be performed at 420b based on the task information and such extracted features may then be fed into the trained machine learning model 430b and make a priority prediction. Such priority predictions directed to all current tasks are then stored in 440b. In some embodiments, current tasks may be ranked according to their corresponding priorities to produce a list of priority ranked tasks in 460.

FIG. 4C depicts an exemplary scheme 440 for obtaining and applying AI-based personalized model for predicting task duration in AI-based task arrangement, in accordance with an embodiment of the present teaching. The scheme similarly includes a training pipeline and a serving pipeline, for training and applying a personalized duration prediction model 430c via machine learning. At training time, training data 410 is provided with extracted labels 410c (serve as ground truth) and features 420c extracted from the historic task management records with past tasks and the user's previous interactions. As discussed herein, the training data 410 may also include information on previous task order adjustment by the user via interactions with respect to past scheduled sequence of past tasks in the calendar. The labels 410c and features 420c from the past tasks and the user's previous interactions may include user's previous task finish time and other data in terms of length of time to accomplish each of the past tasks. Such information is helpful to train the task duration prediction model because it reflects the user's typical working duration on previous similar tasks which can be characterized to predict the future duration needed on similar tasks. Features included in the training data may include, but not limited to task features, user features, user and task interaction features, task completion information, etc. The labels and features are fed into AI-based machine learning model 430c to learn a model for predicting task durations in a personalized manner. The learning scheme may adopt any type of supervised machine learning model, including but not limited to logistic regression, naive bayes, support vector machine, decision tree, adaboost, gradient boosting machine, random forest, neural networks, and any type of deep learning architectures etc. Once the model is trained, it can be used by the serving pipeline to make predictions based on input current tasks from 420. Specifically, for any of current tasks from 420, features will be extracted by process 420c and the extracted features are then fed into the trained machine learning model 430c to make duration predictions 440c based on the extracted features. The predicted durations are stored as time constraints in 470 and output to the next steps in the system.

FIG. 4D depicts an exemplary scheme 450 for obtaining and applying AI-based personalized model 430d for predicting task start time in task rearrangement, in accordance with an embodiment of the present teaching. The personalized start time prediction model 430d is obtained via machine learning based on training data from 410. As shown, the model diagram can be split into a training pipeline and a serving pipeline. At training time, the labels 410d and features 420d from the training data of past tasks including the user's previous task start time and finish/miss behaviors etc. on past tasks that were arranged into the calendar. This information is helpful to train a task start time prediction model because it reflects the user's start time preference on previous similar tasks which can be helpful to predict the user's future start time on similar tasks. The features may also include various types of features from including but not limited to task features, user features, user, different start times for different tasks, and task interaction features etc. The labels and features are fed into AI-based machine learning model 430d to train a start time prediction model. As discussed herein, the learning algorithm can be any type of supervised machine learning model, including but not limited to logistic regression, naive bayes, support vector machine, decision tree, adaboost, gradient boosting machine, random forest, neural networks, and any type of deep learning architectures, etc. Once the model is adequately trained, it is used by the serving pipeline to make predictions. Specifically, for any of the current tasks in 420, the same feature engineering process 420d is used to extract the same type of features, then fed into the trained machine learning model 430d and make start time predictions 440d. This is done for all current tasks and these predicted start times are stored as time constraints in 470 and output to the next steps in the system.

FIG. 4E illustrates exemplary approaches for AI-based personalized global task optimization in AI-based calendar task arrangement, in accordance with an embodiment of the present teaching. In this illustrated embodiment, the AI-based personalized global task optimization is implemented based on a global task optimization module 480 used in calendar task rearrangement. Although a specific example is provided herein, there are other alternative ways to implement the global optimization module 480. For example, in some embodiments, the global optimization is achieved via a constrained optimization approach. An alternative embodiment for global task optimization may be a greedy algorithm approach to generate calendar tasks arrangement. Other approaches are also possible. In some embodiments, different global optimization may be implemented by integrating task global optimization results generated using different approaches to produce a combined result on calendar tasks arrangement 490.

The upper part of FIG. 4E depicts an exemplary flowchart for the constrained optimization embodiment. In this exemplary embodiment, the prioritized ranked tasks in 460, generated by module 430, and time constraints in 470, generated by modules 440 and 450, may first be converted into, e.g., equality and inequality linear constraints 410e. Such linear constraints may be incorporated into a linear programming objective function 420e, which may be solved with, e.g., a simplex algorithm or other optimization algorithms specified in 430e. The global optimization scheme as discussed herein generates a task arrangement in a calendar that may consider the priorities of different tasks as provided by 460 and satisfy the various constraints specified in 470.

The lower part of what is depicted in FIG. 4E corresponds to an exemplary flowchart for an exemplary greedy algorithm. In operation, a process implemented in accordance with the greedy algorithm may start by, e.g., checking if the list of prioritized tasks still has more tasks to be arranged into the calendar 411e. If not, i.e., all tasks have already been arranged to certain spot in the calendar 491e, the process ends. If there are additional tasks to be arranged, the next task in the list is obtained, at 421e, from list in 460 for further arrangement. In some embodiments, the next task to be processed may be one that has the next top priority. To incorporate the next task into the global optimized arrangement, the algorithm may check, at 431e, to see if the task has a start time or not. If the current task does not have an associated start time, then the process obtains a first suggested start time at 441e and checks, at 451e, if the current task can fit into the calendar using the suggested start time satisfies all other constraints, i.e., without collision with other tasks in the calendar. If the suggested start time satisfies all constraints, i.e., the current task can fit in the calendar using the suggested start time, then the task is added to the calendar at 461e with the suggested start time. The process then goes back to 411e. If the suggested start time causes a collision, a next suggested start time may be selected to assign the current task. If all start times have been exhausted, the process may then proceed to prompt the user to choose to, e.g., either append the current task to end of the calendar at 471e or manually suggest some additional start time for this task at 481e. The process continues until a task start time for the current task is identified so that it can be fit into the calendar. With this greedy processing, each of the current tasks may be assigned to a certain start time in the calendar. The resulted calendar with fit tasks is then stored in 490. 0

More exemplary embodiments related to the AI-based task management system are discussed below with respect to the remaining figures. FIG. 5A is a flowchart of an exemplary process of user interactions to add/update a task with AI-based task priority determination and task rearrangement, in accordance with an embodiment of the present teaching. A user may choose, at 510a, to add or update a task. In this situation, the task to be added or updated may first be checked, at 520a, for duplication based on an AI-based task duplication detection model to make sure that the task to be added/updated is not a substantially duplicated one as compared with any existing tasks. If the duplication test is passed, various previously learned AI-based models, e.g., the priority prediction model 430, duration prediction model 440, and start time prediction model 450, may be invoked, at 530a, to produce predictions associated with the task. Based on the predictions, the task is then added/updated, at 540a, and, as discussed herein, it makes sure that the addition/update is consistent and coherent across all views. In some embodiments, the adding/updating is performed automatically but the option of allowing the user to manually add/update may also be permitted. As discussed herein, when the prediction models are trained in a personalized manner, the predictions generated based on them are also personalized so that the task is added/updated also in an intelligently and personalized fashion. Base on the added/updated task, the overall schedule for all tasks assigned to the calendar may be rearranged to optimize based on the personal preferences.

FIG. 5B is a flowchart of an exemplary process of removing/marking a completed task with AI-based automated task list update and rearrangement, in accordance with an embodiment of the present teaching. When a user chooses to remove a task or mark a task done, the system may prompt, at 510b, the user to mark the task as done. Any information associated with the task may be archived at 520b for, e.g., future references such as being used as training data. The task may then be removed, at 530b, from all views including from the calendar view. The remaining tasks may then be rearranged, at 540b, using the AI-based calendar auto rearrangement module to rearrange the remaining tasks automatically and intelligently in a personalized fashion.

As discussed herein, FIG. 5C illustrates exemplary types of information/statistics automatically made available via AI-based models, in accordance with an embodiment of the present teaching. The exemplary types of meta overview statistics associated with task management may be displayed in the dashboard display area 240a. Exemplary types of statistics or information related to different tasks may include, but are not limited to, tasks completion rate, tasks missing rate, calendar packed rate, a rate of tasks that cannot be scheduled, productivity flow etc. Although illustrated herein as a sequence of listed information, other form of information presentation may also be optionally provided such as in speech form, in graphical form, etc.

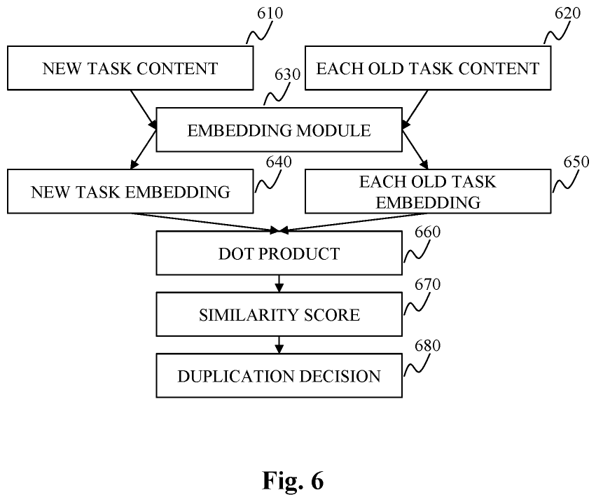

FIG. 6 depicts an exemplary scheme for automatically detecting duplicated tasks via an AI-based approach, in accordance with an embodiment of the present teaching. As discussed herein, each time when there is a new task or updated task 610 provided to the system, the system may compare the new/updated task with each existing task 620 to detect duplication. In some embodiments, embedding modules may be learned, at 630, via machine learning so that it can be used to map a task with parameters to a task embedding. The learned embedding module may then be used to map, at 640, the new task content to generate a new task embedding. Similarly, each of the existing tasks from 620 may be mapped, at 650, to an existing task embedding. To determine whether the new task is a duplicate (or substantially duplicate) of an existing task, in some embodiment, a dot product of the new task embedding, and the existing task embedding is computed at 660 and a similarity score may be computed, at 670, based on the result of the dot product. A decision on whether the new task is a duplicate of the existing task is them made, at 680, based on the similarity score. In some embodiments, the embedding modules may include text embedding modules including but not limited to word2vec, Gloves, Elmo, BERT, etc., and image-based embeddings, voice-based embeddings, video-based embeddings, etc.

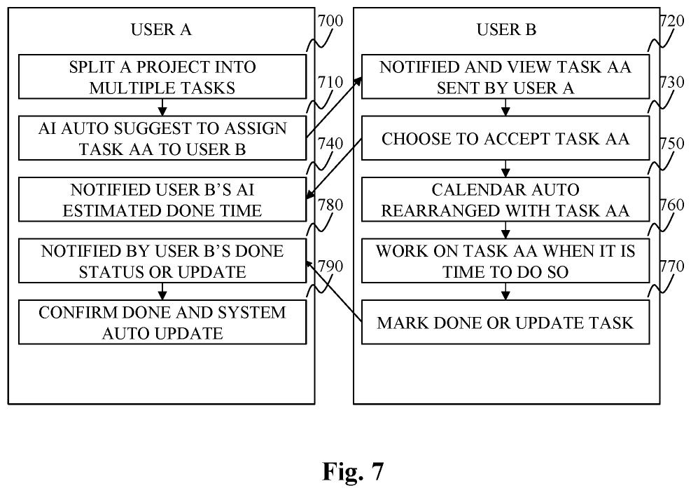

FIG. 7 depicts an exemplary scheme of applying AI-based personalized task management framework to collaborated team project management, in accordance with an embodiment of the present teaching. In this exemplary application, a user A may desire to start a project and split, at 700, the project into multiple tasks to be accomplished by different participants of the project in a time coordinated manner. The AT-based task management approach as disclosed herein according to the present teaching may be applied to manage a project via coordinated task management across multiple project participants. In this exemplary application, a project with two participants is used to illustrate the concepts. However, this is not to be used as a limitation to the application of the task management concept as applied in managing a project with multiple participants.

To apply the task management scheme according to the present teaching to project management, AI-based models may be obtained by training, via machine learning, based on historic data related to the project participants. In some embodiments, the training may involve learning of not only each individual user's habits and preferences (as discussed above) but also characteristics on the collaboration of the participants in the past, if some or all of the participants have collaborated previously. In this case, the models obtained via training capture not only participants' individual preferences/limitations but also preferences/limitations on their cooperation. When such models are used to manage a project with multiple participants, they can be used to determine how to assign tasks of the project to different participants based on learned preferences/limitations on how these participants collaborate and then manage the assigned tasks to each individual participant in the manner as discussed herein.

In some scenarios, participants of a project may be allocated to work together for the first time so that information about their past collaboration is not available. That is, the trained models are obtained based on past histories of individual participants without information on their past collaboration among the participants. In this case, certain assumption may be adopted as to assigning tasks related to the project to participants. For instance, a leader participant (such as user A in FIG. 7) may assign tasks to other participant(s). Alternatively, the assignment of tasks may be carried out automatically based on, e.g., the profiles of each participant or the assumption that there is no preference/limitation on assigned tasks, i.e., each of the participants may be assigned to any of the tasks of the project. In some scenarios, it is also possible that only some (not all) of the participants may have collaborated previously (i.e., some have not) and the trained models may capture the preferences/limitations in collaboration between/among only some of the participants. Task assignment to those who have collaborated previously may be done based on the models and assignment to the remaining ones may be done by other means as discussed herein.

Going back to the example shown in FIG. 7, there are two users A and B (participants) involved. Assuming that users A and B have collaborated previously, and the models capture the individual preferences/limitations of users A and B in their task management but also the collaboration preferences/limitations. The AI system as disclosed herein may automatically suggest, at 710 based on the models, to assign one of the tasks (e.g., task AA) involved in the project to user B given B's previous task completion experience and previous collaborations between user A and user B. Then user B is notified, at 720, to view the task AA. User B may then choose to accept the assignment of task AA at 730. Then the duration that user B needs to complete task AA is estimated based on the personalized AI-based duration prediction model. The system notifies, at 740, user A the user B's acceptance of assigned task AA as well as the estimated duration for user B to complete task AA. User B's calendar is then automatically rearranged and calendared, at 750, upon acceptance of task AA with the estimated duration in a personalized way using the global optimization module as disclosed herein according to the present teaching. User B may then proceed to start to work on, at 760, task AA according to a start time estimated using AI-based start time prediction model associated with user B. When task AA is completed, user B marks, at 770, task AA in the corresponding calendar as done. At that point, user A is notified, at 780, the completed status with regard to task AA and confirms, at 790, if task AA is done correctly and if so, system will then automatically rearrange user A's calendar with task AA (mark it done).

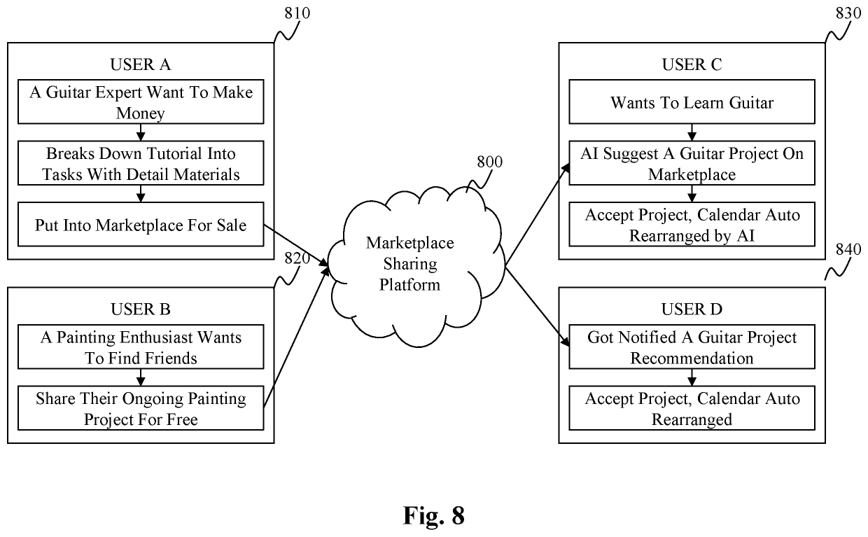

FIG. 8 depicts an exemplary application of the AI-based personalized task management to online marketplace knowledge sharing, in accordance with an embodiment of the present teaching. In this exemplary illustration of using the AI-based personalized task management scheme to online marketplace knowledge sharing, there are four users, user A 810, user B 820, user C 830, and user D 840, connected to a marketplace sharing platform 800, to share knowledge and management thereof based on the AI-Based task management framework as disclosed herein. In this example, user A 810 may be a guitar expert who wants to make money by sharing the expertise in guitar playing. User B 820 may be a person enthusiastic about painting who desires to find friends. User C may be a person who desires to learn guitar and may want to gain some knowledge about guitar playing. User D may be a person who is looking for any interesting knowledge on the network. In some embodiments, each of these users in FIG. 8 may represent a group of similarly situation users.

Users connected to the marketplace sharing platform 800 may share knowledge or expertise by leveraging the AI-based task management framework discussed herein. That is, users on the marketplace sharing platform not only can be engaged with each other based on their interests but also the engagement is realized using the AI-based task management scheme to make the engagement concrete, executable, and manageable. For example, user A (or a user in user group A) may express, on the marketplace sharing platform, the interest to share the guitar knowledge, user A may also provide, e.g., information about break-down tutorial sessions for different levels of sharing, each of which may be selected and calendared as a task that effectuate the sharing of knowledge conveyed in that tutorial session. When the break-down sessions from user A are accepted by another user, e.g., user C 830, each of these break-down tutorial sessions may be automatically arranged according to the existing calendar of user C and individual tutorial sessions may be automatically calendared in the calendar of user C based on AI-based models associated with user C in a personalized way. In some embodiments, if knowledge sharing sessions require presence of both participants (e.g., via internet connection such as zoom), the calendar of user A may also need to be tasks and the time for knowledge sharing is determined intelligently based on the existing calendars of both user A and user C as well as these individuals' preferences/limitations captured by their respective AI-based models (priority prediction model, duration prediction model, . . . , start time prediction model) and calendar such knowledge sharing sessions as tasks in the calendars of participating parties in a personalized and intelligent manner. When calendaring the knowledge sharing sessions for different participants, their respective calendars may need to be rearranged accordingly as discussed here given the know tasks on knowledge sharing. Once the knowledge sharing sessions are calendared in a user's calendar, the AI-based task management scheme as disclosed herein may be used to manage the tasks on the calendars of different participants.

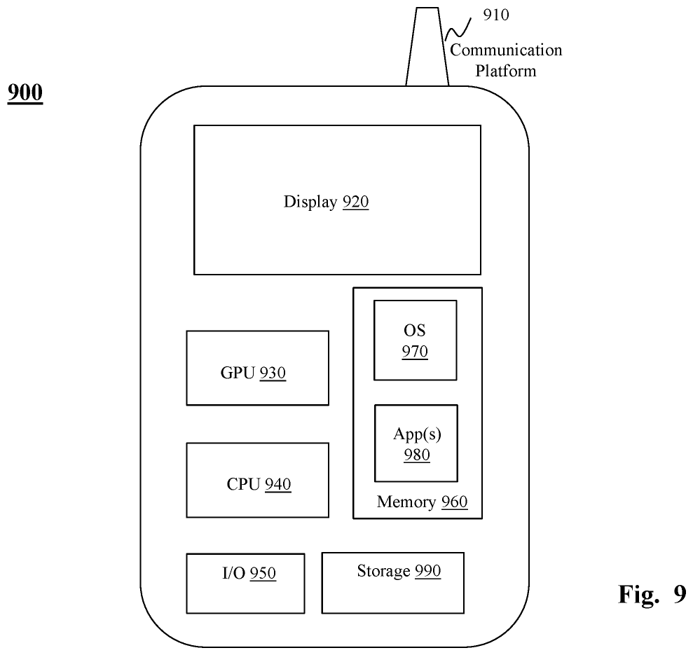

FIG. 9 is an illustrative diagram of an exemplary mobile device architecture that may be used to realize a specialized system implementing at least some parts of the present teaching in accordance with various embodiments. In this example, the user device on which the present teaching is implemented corresponds to a mobile device 900, including, but is not limited to, a smart phone, a tablet, a music player, a handled gaming console, a global positioning system (GPS) receiver, and a wearable computing device (e.g., an eyeglass such as a smart glass, a wristwatch such as a smart watch, etc.), or in any other form factor. Mobile device 900 may include one or more central processing units (“CPUs”) 940, one or more graphic processing units (“GPUs”) 930, a display 920, a memory 960, a communication platform 910, such as a wireless communication module, storage 990, and one or more input/output (I/O) devices 940. Any other suitable component, including but not limited to a system bus or a controller (not shown), may also be included in the mobile device 900. As shown in FIG. 9, a mobile operating system 970 (e.g., iOS, Android, Windows Phone, etc.), and one or more applications 980 may be loaded into memory 960 from storage 990 in order to be executed by the CPU 940. The applications 980 may include a browser or any other suitable mobile apps for managing a conversation system on mobile device 900. User interactions may be achieved via the I/O devices 940 and provided to the automated dialogue companion via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

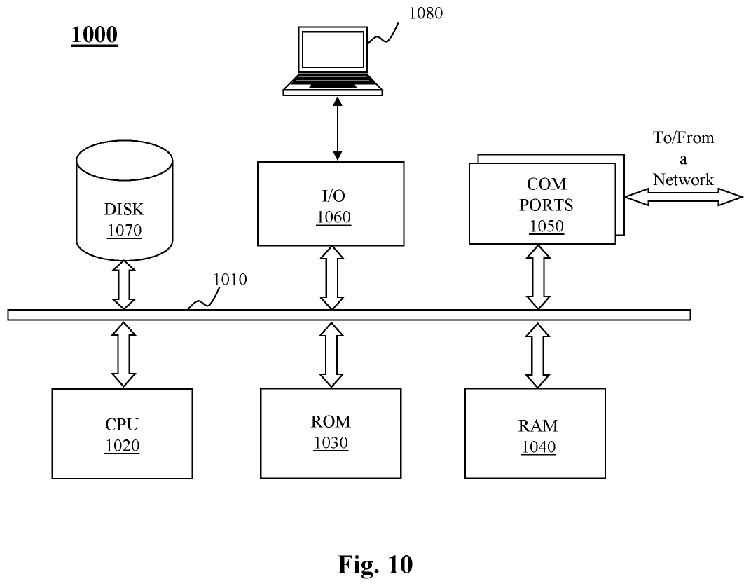

FIG. 10 is an illustrative diagram of an exemplary computing device architecture that may be used to realize a specialized system implementing at least some parts of the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 1000 may be used to implement any component of conversation or dialogue management system, as described herein. For example, conversation management system may be implemented on a computer such as computer 1000, via its hardware, software program, firmware, or a combination thereof. Although only one such computer is shown, for convenience, the computer functions relating to the conversation management system as described herein may be implemented in a distributed fashion on a number of similar platforms, to distribute the processing load.

Computer 1000, for example, includes COM ports 1050 connected to and from a network connected thereto to facilitate data communications. Computer 1000 also includes a central processing unit (CPU) 1020, in the form of one or more processors, for executing program instructions. The exemplary computer platform includes an internal communication bus 1010, program storage and data storage of different forms (e.g., disk 1070, read only memory (ROM) 1030, or random-access memory (RAM) 1040), for various data files to be processed and/or communicated by computer 1000, as well as possibly program instructions to be executed by CPU 1020. Computer 1000 also includes an I/O component 1060, supporting input/output flows between the computer and other components therein such as user interface elements 1080. Computer 1000 may also receive programming and data via network communications.

Hence, aspects of the methods of dialogue management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with conversation management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the AI-based task management framework and components thereof as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one machine including at least one processor, memory, and communication platform capable of connecting to a network for task management, comprising:
receiving information related to at least one task to be carried out by a user;
predicting automatically multiple features associated with each of the at least one task based on a plurality prediction models, wherein the plurality of prediction models are derived based on historic information related to the user in carrying out past tasks;
accessing a calendar associated with the user; and
automatically scheduling the at least one task with respect to the calendar based on the multiple features predicted for each of the at least one task to generate an updated calendar with the at least one task scheduled therein.

2. The method of claim 1, wherein the multiple features associated with each of the at least one task include:
a priority of the task;
a duration of the task; and
a start time for the task.

3. The method of claim 1, wherein the plurality of prediction models are obtained via machine learning and trained based on training data including the historic information.

4. The method of claim 3, wherein the plurality of prediction models include:
a priority prediction model personalized via training based on the training data and to be used for predicting a priority of each of the at least one task in a personalized manner;
a duration prediction model personalized via training based on the training data including statistics about the user's past execution of different types of past tasks; and
a start time prediction model personalized via training based on the training data including information indicative of preferences of the user in start time of different types of past tasks.

5. The method of claim 1, wherein
the calendar associated with the user has one or more previously scheduled tasks therein; and
the updated calendar includes both the previously scheduled tasks and the at least one task scheduled therein.

6. The method of claim 5, wherein the step of scheduling the at least one task comprises:
obtaining an estimated schedule for each of the at least one task via:
if an entry in the calendar exists that satisfies the multiple features of the task, estimating the entry as the schedule for the task in the calendar, and
if no entry in the calendar satisfies the multiple features of the task, estimating a rearrangement of one or more of the previously scheduled tasks in the calendar to create an entry for the task that satisfies the multiple features of the task.

7. The method of claim 6, wherein the entry in the calendar corresponds to a duration represented by a start time and an end time in the calendar.

8. The method of claim 6, further comprising performing global optimization with respect to the at least one estimated schedule for the at least one task and the previously scheduled tasks in the calendar to generate a globally optimized schedule for both the at least one task and the previously schedule tasks.

9. The method of claim 8, further comprising generating the updated calendar based on the globally optimized schedule.

10. The method of claim 5, further comprising detecting, prior to the scheduling each of the at least one task, any duplicated task by:
obtaining a first representation of each of the previously scheduled tasks in the calendar;
with respect to each of the at least one task,
obtaining a second representation of the task,
determining similarity between the second representation of the task and each of the first representations for the previously scheduled tasks,
removing the task from the at least one task if the similarity satisfies a pre-determined condition.

11. Machine readable and non-transitory medium having information recorded thereon for task management, wherein the information, when read by the machine, causes the machine to perform the following steps:
receiving information related to at least one task to be carried out by a user;
predicting automatically multiple features associated with each of the at least one task based on a plurality prediction models, wherein the plurality of prediction models are derived based on historic information related to the user in carrying out past tasks;
accessing a calendar associated with the user; and
automatically scheduling the at least one task with respect to the calendar based on the multiple features predicted for each of the at least one task to generate an updated calendar with the at least one task scheduled therein.

12. The medium of claim 11, wherein the multiple features associated with each of the at least one task include:
a priority of the task;
a duration of the task; and
a start time for the task.

13. The medium of claim 11, wherein the plurality of prediction models are obtained via machine learning and trained based on training data including the historic information.

14. The medium of claim 13, wherein the plurality of prediction models include:
a priority prediction model personalized via training based on the training data and to be used for predicting a priority of each of the at least one task in a personalized manner;
a duration prediction model personalized via training based on the training data including statistics about the user's past execution of different types of past tasks; and
a start time prediction model personalized via training based on the training data including information indicative of preferences of the user in start time of different types of past tasks.

15. The medium of claim 11, wherein
the calendar associated with the user has one or more previously scheduled tasks therein; and
the updated calendar includes both the previously scheduled tasks and the at least one task scheduled therein.

16. The medium of claim 15, wherein the step of scheduling the at least one task comprises:
obtaining an estimated schedule for each of the at least one task via:
if an entry in the calendar exists that satisfies the multiple features of the task, estimating the entry as the schedule for the task in the calendar, and
if no entry in the calendar satisfies the multiple features of the task, estimating a rearrangement of one or more of the previously scheduled tasks in the calendar to create an entry for the task that satisfies the multiple features of the task.

17. The medium of claim 16, wherein the entry in the calendar corresponds to a duration represented by a start time and an end time in the calendar.

18. The medium of claim 16, wherein the information, when read by the machine, further causes the machine to carry out the step of performing global optimization with respect to the at least one estimated schedule for the at least one task and the previously scheduled tasks in the calendar to generate a globally optimized schedule for both the at least one task and the previously schedule tasks.

19. The medium of claim 18, wherein the information, when read by the machine, further causes the machine to perform the step of generating the updated calendar based on the globally optimized schedule.

20. The medium of claim 15, wherein the information, when read by the machine, causes the machine to further perform the step of detecting, prior to the scheduling each of the at least one task, any duplicated task by:
obtaining a first representation of each of the previously scheduled tasks in the calendar;
with respect to each of the at least one task,
obtaining a second representation of the task,
determining similarity between the second representation of the task and each of the first representations for the previously scheduled tasks,
removing the task from the at least one task if the similarity satisfies a pre-determined condition.
